(19) United States
(12) Patent Application Publication
(10) Pub. No.: US 2012/0033400 A1
(43) Pub. Date: Feb. 9, 2012

(54) Dimmable high intensity LEDs luminaire with emergency ballast for parking areas

(75) Inventors: Rodrigo Ruizpalacios Remus, Queretaro (MX); Oscar Suarez Camacho, Queretaro (MX); Luis Felipe Cruz Velazquez, Queretaro (MX); Gerardo Gonzalez Montiel, Queretaro (MX); Raul Escareño Romero, Queretaro (MX); Roberto Camberos López, Queretaro (MX); Jose Antonio Cardenas Cervantes, Queretaro (MX); Jose Villafaña Nuñez, Queretaro (MX)

(73) Assignee: Servicios Condumex

(21) Appl. No.: 12/927,183

(22) Filed: Nov. 8, 2010

(30) Foreign Application Priority Data
Aug. 4, 2010 (MX) MX/A/2010/008576

(51) Int. Cl. F21V 19/04

(52) U.S. Cl. 362/20

(57) ABSTRACT

A high intensity dimmable LEDs luminaire with emergency ballast for car parks for use with fixed or dimmable output comprising a semi-concave shell, characterized in that it has a passage at the center of the skeleton having an inverted “U” shape to accommodate an AC current source, emergency ballast, a set of batteries and electrical harness and in that it has at its concave side ends, a plurality of PCB or MCPBC card and metal heat dissipating elements.

### BACKGROUND OF THE INVENTION

1. Field of the Invention

The present invention relates to high intensity fixed or dimmable self ranging LEDs electronic luminaires for covered car parks or closed areas such as corridors or building ramps, with regulated electricity supply and hermetic shell having a dustproof and weatherproof seal element, wherein the following elements are accommodated: electrical harness, heat dissipating elements, a plurality of light emitting diodes (LEDs), electricity supply source, emergency batteries, emergency ballasts and dimming sensors; and a cover of illumination diffusion screen with low electricity consumption, long life and minimum maintenance.

2. Prior Art

The manufacture of some types of luminaires based on light emitting diodes or LEDs such as the ones taught in our Mexican Patent Application MX/a/2008/007268 has been growing. In said document, an electronic luminaire type based on a plurality of LEDs operating with alternating current and supplying regulated direct current with a plastic base or shell having heat dissipating elements placed on multiple bars or individual elements per LED is described. The said electronic luminaire is useful for indoor illumination patterns such as offices or closed spaces.

In European patent EP 1906 081 A1, a fixed luminous flux LED is described that comprises a shell forming a substantially airtight and watertight chamber, having electronic LED conductors within said chamber and a LEDs arrangement secured onto the shell and weather protected, said LEDs arrangement having at least one LEDs ordered module mounted on a LEDs heat dissipating element. In one preferred mode, the shell is a perimeter structure such that the watertight chamber substantially surrounds the LEDs arrangement. Said invention is also considered for use in offices or small spaces and its main feature is the design of its shell to accommodate the parts constituting the luminaire.

In US Patent Application Publication 2008/0078224 A1, a modular LEDs unit is described that is separately mounted on interconnected and preferably extruded heat dissipating elements, each heat dissipating element having preferably a shape appropriate to engage and hold a LEDs module in its place, and a plurality of fins appropriately distributed to facilitate the integration of the elements of the unit.

Another object of the instant invention is the design of the shell.

### OBJECT OF THE INVENTION

One object of the instant invention is to develop a nearly flat semi-concave electronic LEDs-based luminaire, that can supply an illumination with higher homogeneous diffusion permitting the reduction of the effect known as cave effect, i.e., the reduction of the shade projected onto the walls and roof in the upper part of the illuminated area.

Another objective of the invention is to permit a more homogeneous diffusion of the illumination according to the delimited area of observation wherein the relation between maximum/minimum illumination ^{s} 1 or about 1.

### DESCRIPTION OF THE INVENTION

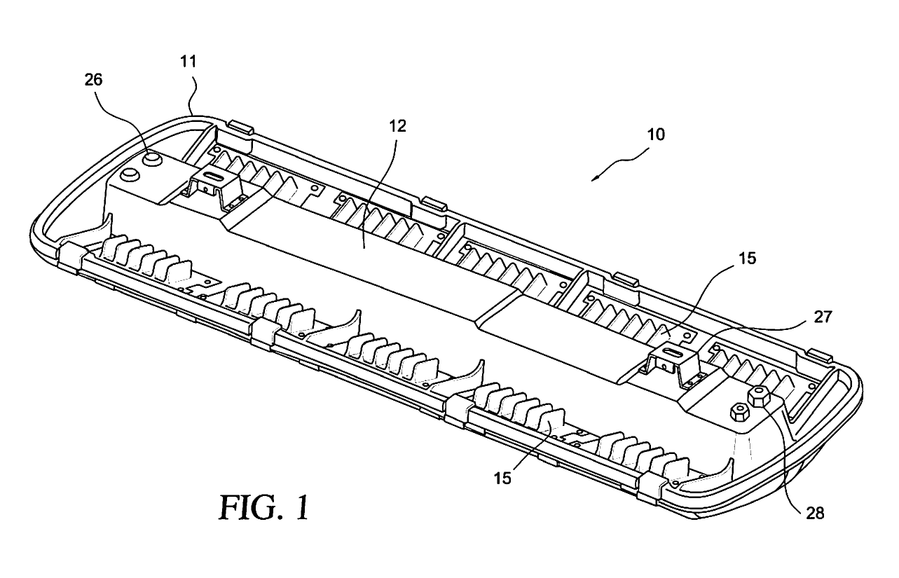

Hereinafter, the invention will be described according to the drawings of FIGS. 1 to 13, wherein:

FIG. 1 is a top plan perspective view of the LEDs luminaire.

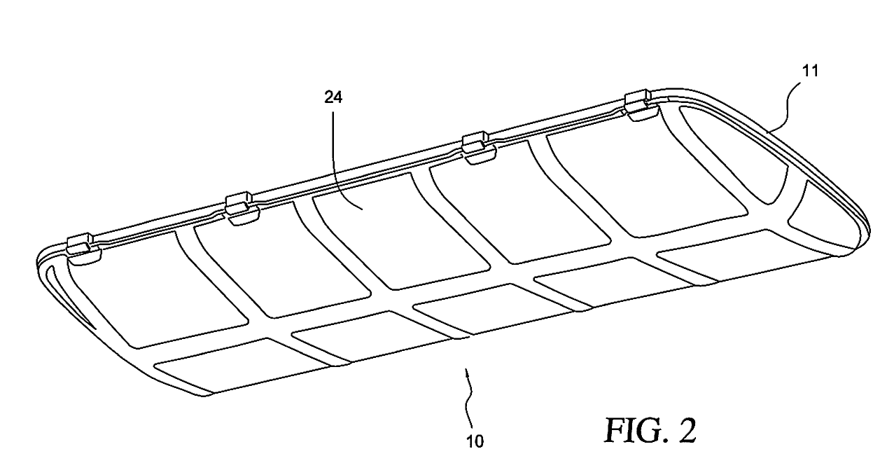

FIG. 2 is a bottom plan perspective view of the LEDs luminaire of FIG. 1.

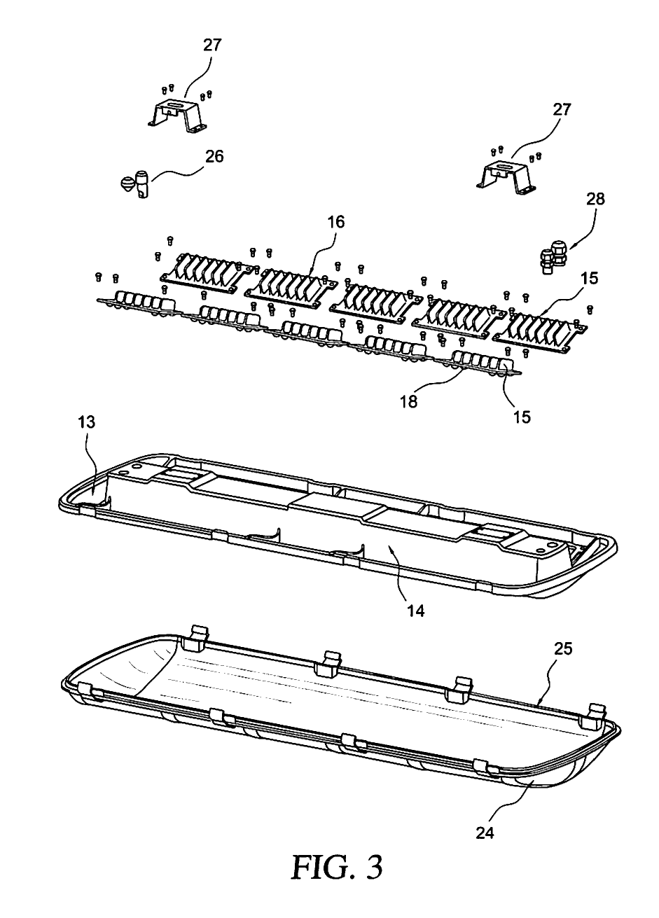

FIG. 3 is a top plan exploded perspective view of the parts integrating the luminaire of FIGS. 1 and 2.

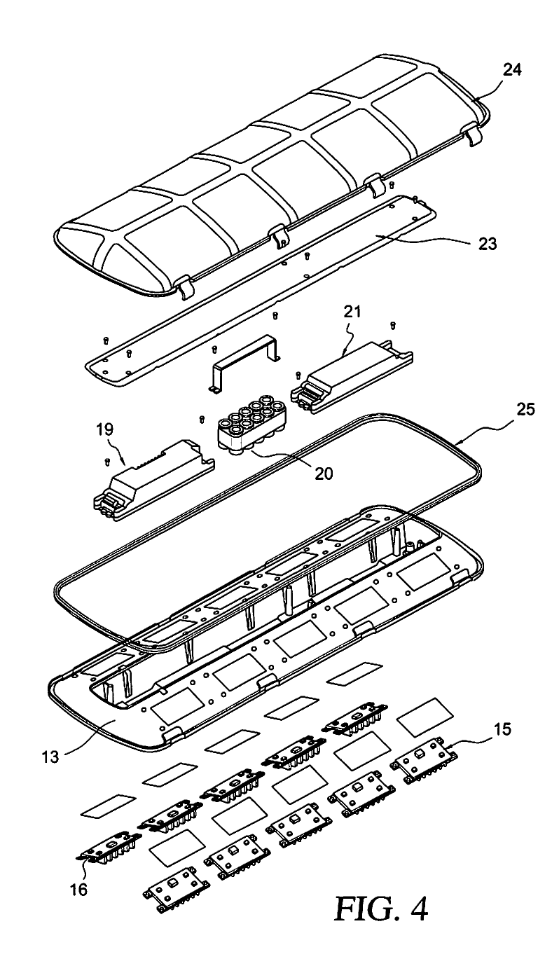

FIG. 4 is a bottom plan perspective view of the luminaire of FIG. 3.

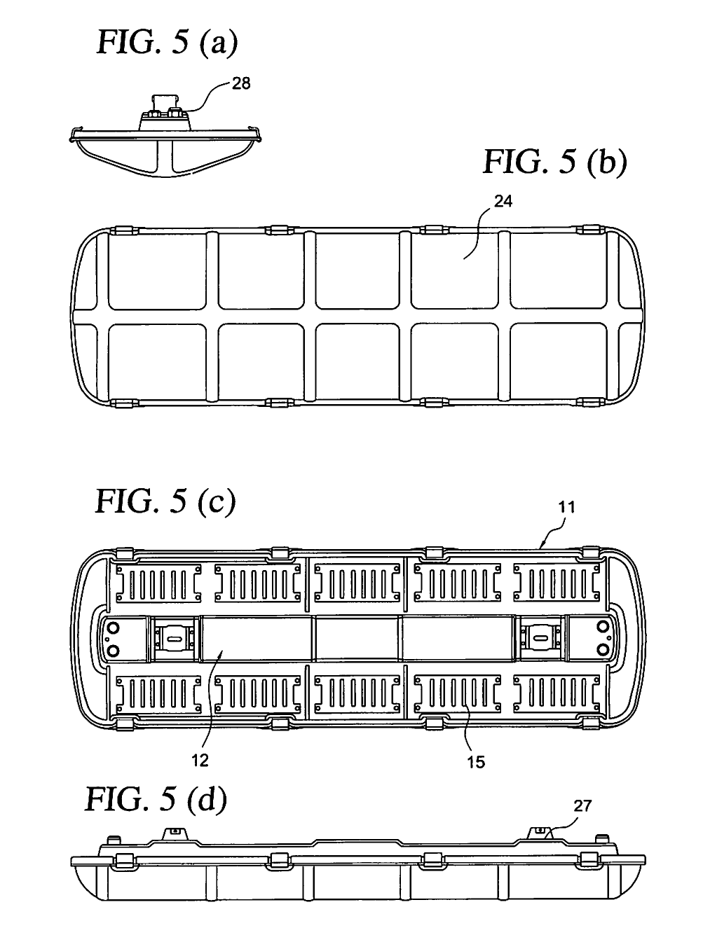

FIG. 5 is a front end view a), bottom plan b), top plan c) and side end d) of the luminaire;

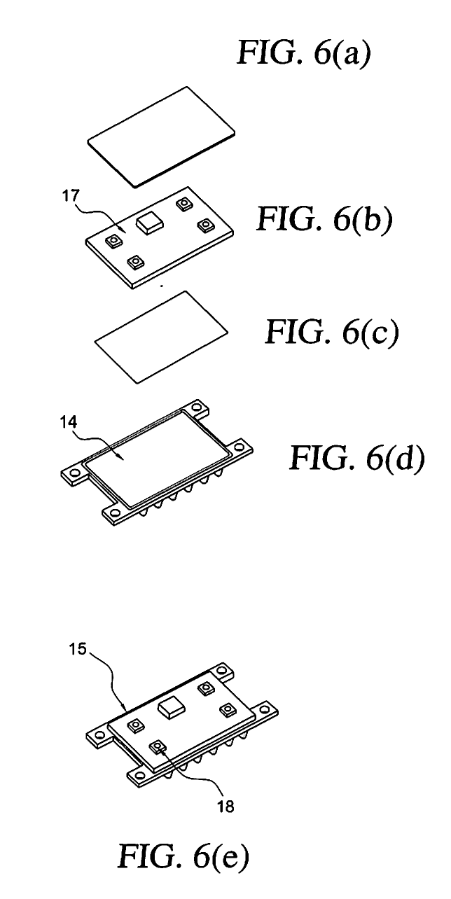

FIG. 6a is a perspective view of the plate frame;

FIG. 6b is a perspective view of LEDs card;

FIG. 6c is a perspective view of the adhesive thermal tape;

FIG. 6d is a top plan view of the upper part of the card;

FIG. 6e is a bottom plan view of a LEDs module and heat dissipating elements;

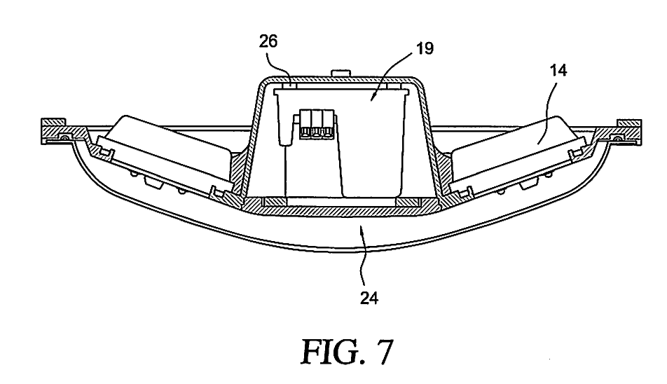

FIG. 7 is a front view of one of the short ends of the luminaire;

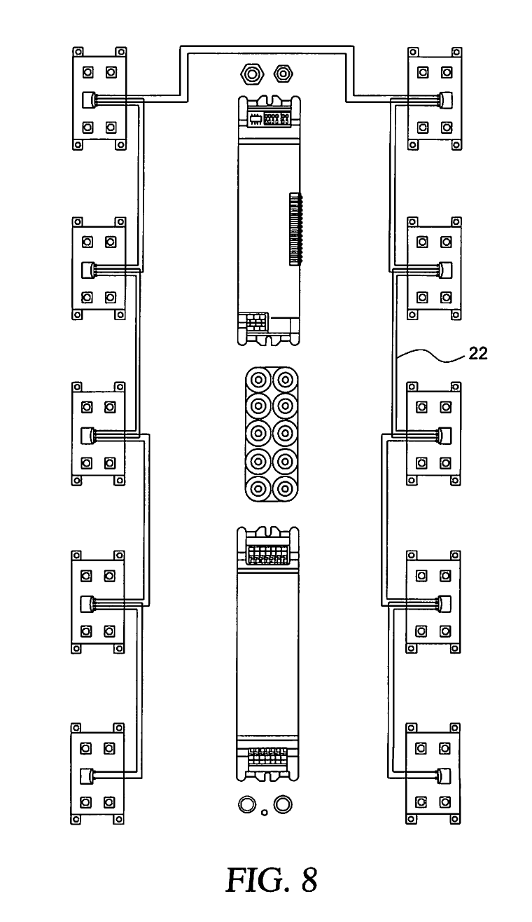

FIG. 8 is an electric circuit view of the luminaire;

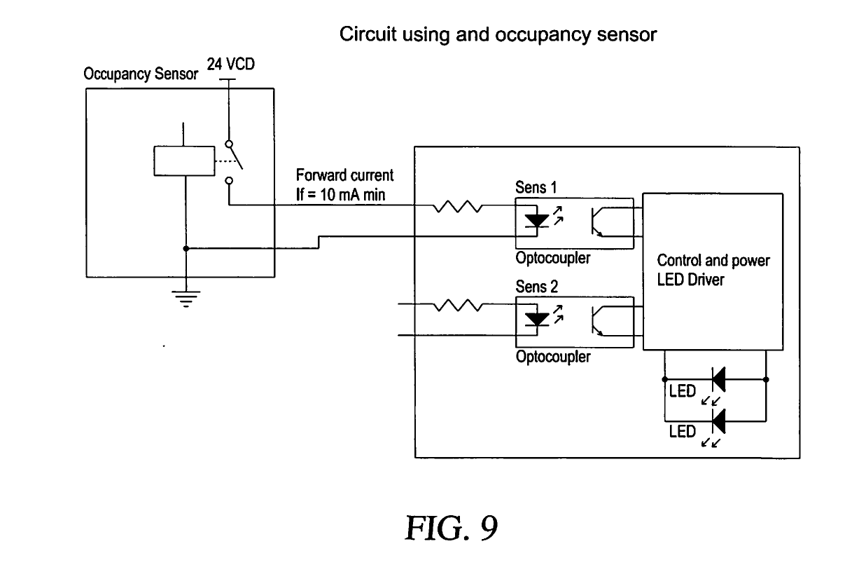

FIG. 9 is a circuit diagram with a movement sensor;

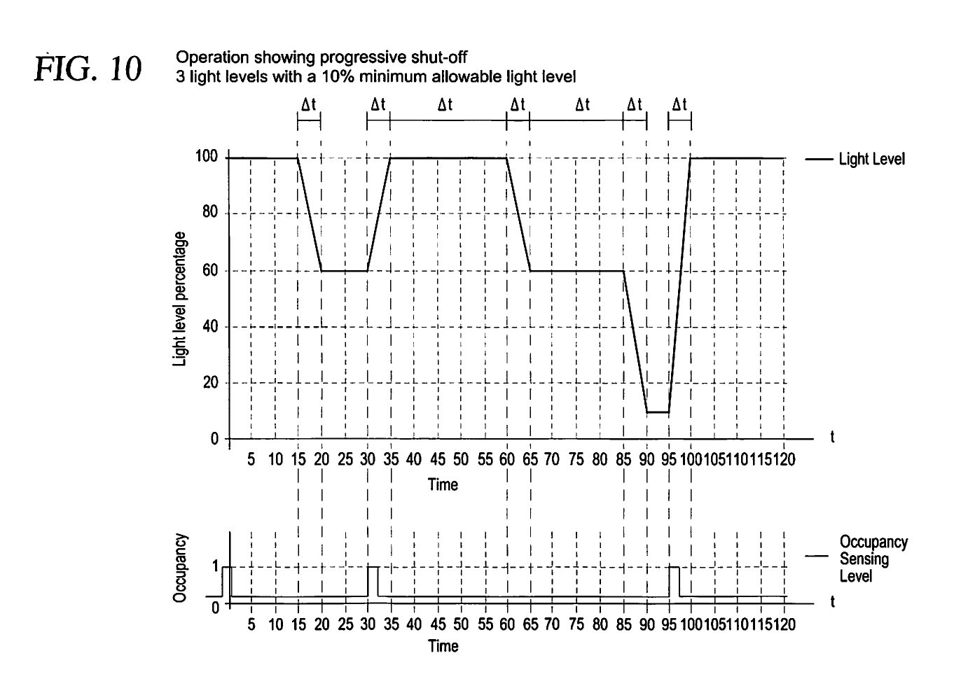

FIG. 10 is an operation graph with 3-level progressive turning off and 10% minimum permissible level;

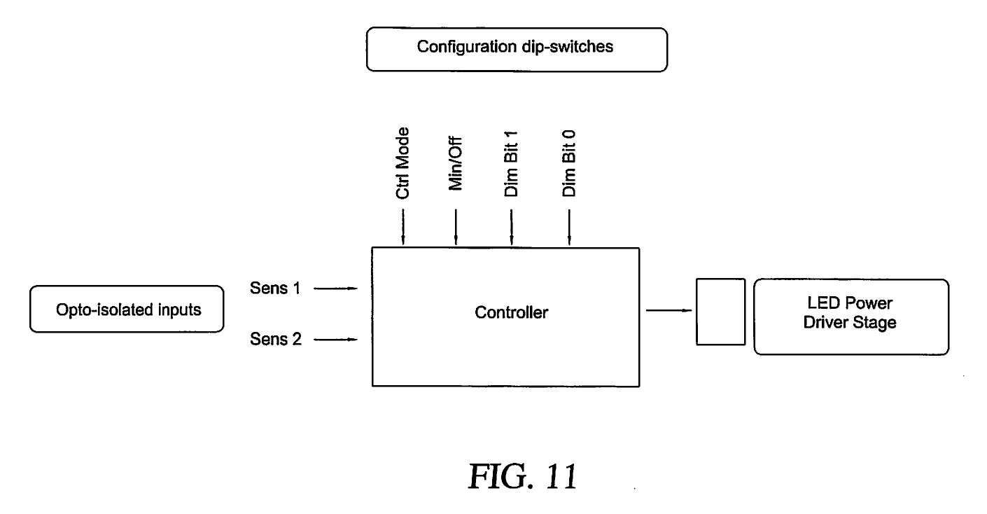

FIG. 11 is a block diagram of configuration breakers;

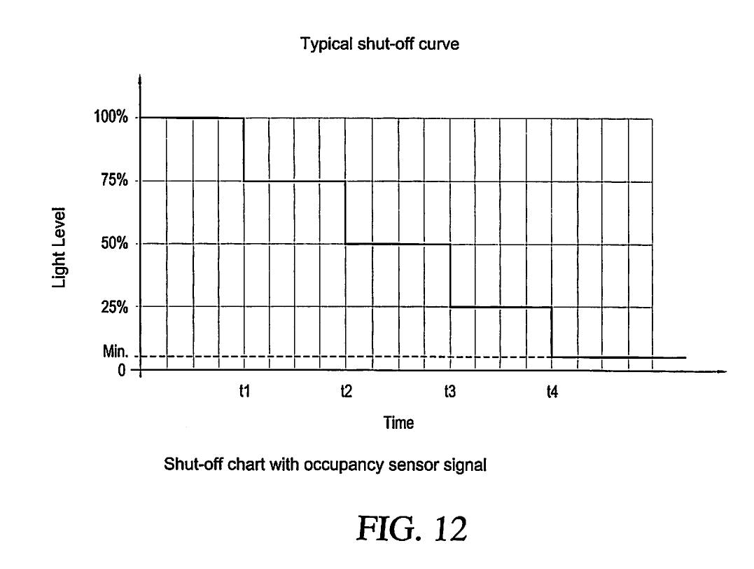

FIG. 12 is a typical curve diagram of progressive turning off;

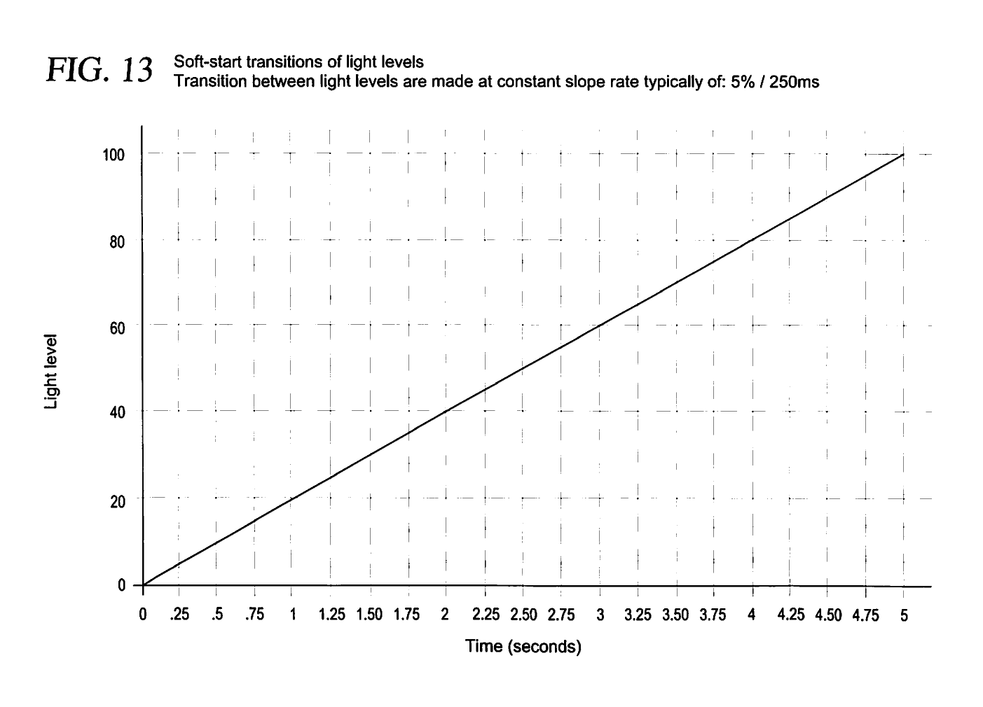

FIG. 13 is a soft transition curve diagram.

The instant invention relates to LEDs electronic luminaire 10, FIGS. 1 and 2, for illuminating industrial or commercial closed areas, toll or surveillance booths and preferably, car parks or ramps and corridors of buildings or intelligent buildings, the main design characteristic of which being that it can be used with fixed or dimmable outputs, with self-regulated supply voltage.

According to FIG. 3, the luminaire 10, FIG. 2, comprises the following parts: a rigid plastic structure for self-supporting 11, the rectangular or other shaped luminaire elements having a central inverted “U” shaped passage 12 throughout its length, with inner (not visible) strengthening rims, and projecting longitudinally to form a semi-concave fin type perimeter structure at each end 13, wherein it disposes of a plurality of enhanced flat bases 14 FIG. 4 integrated throughout the area available of said side ends (fins) to receive modules 15, FIGS. 4 and 6, showing a plurality of LEDs on the outer part and heat dissipating elements on the inner part, 16 FIG. 3, being said heat dissipating elements made of aluminum, zinc or mixtures thereof, the module 15 being secured by the simple PCB card or MCPCB 17 of the LEDs, comprising two, three, four or more LEDs 18, FIG. 6, depending on the capacity of the electricity supply source and the thermal dissipation capacity of the LEDs dissipating elements. In the “U” shaped passage 12, the following electrical elements are accommodated: an energy source 19 with fixed or dimmable output; a set of emergency batteries 20 and an emergency ballast 21 containing an electricity source with voltage control regulator; battery charge controller, electricity sensing stage with converter between alternating current AC and battery; an electrical harness 22 FIG. 8, for normal or emergency illumination interconnections, electricity supply and control element placed on the inner walls of the passage 12, and a cover 23 FIG. 4. As shell complement, the luminaire 10 includes a transparent or opaque plastic screen element 24 hermetically closing the shell 11 through a mechanical seal 25.

### Emergency System:

In the outer upper part of the passage 12, the luminaire comprises a breaker (external button to test the working or non working of the emergency system) 26, FIGS. 3 and 7, connected to the emergency harness cables (not shown), a fuse and a LED indicator; it also comprises elements connecting to the general lines of electric supply as well as securing fittings 27 for placement, and compression glands 28, FIG. 5.

### Functioning

### Remote Turning on of the Luminaire

The simple turning on of the luminaire is with fixed or dimmable output while the supply voltage is self-regulated. According to the circuit diagram comprising a movement sensor, FIG. 9, the luminaire 10 would turn itself on at a 100% upon the activation of any of its two control inputs habilitating autonomous operation with known movement sensors or in combination with a control board having a movement sensor, with progressive turning off operation, FIG. 10, (3 levels and 10% minimum permissible level). The inverse turning on procedure is also possible moving one of the dip-breakers to one position or the other.

The luminaire will turn itself off progressively and automatically upon deactivating both inputs Sens 1 and Sens 2, FIG. 9.

The control lines are independent among them and from the AC supply bus. Moreover, they are electrically insulated (opto coupled), permitting the connection of several lamps to one single commercial movement sensor or control relay output, FIG. 9 (circuit with movement sensor).

Remote Turning on/Turning Off

The luminaire can be configured to use the control input Sens 1 to activate 100% turning on, and the input Sens 2 to activate the turning off.

### Progressive Turning Off, FIG. 10

During a one-hour period, the luminaire will progressively reduce its intensity until it reaches the minimum permissible level.

There are four progressive turning off schemes; each scheme comprising various intermediate levels of luminous intensity before reaching the minimum permissible level.

If an entrance signal is triggered before the progressive turning off time has elapsed, the luminaire returns to 100% of its capacity and the waiting cycle starts again. FIG. 10 shows an operation graph with a 3-level progressive turning off and 10% minimum permissible level.

For the turning off levels, configuration breakers, FIG. 11, are available, wherein the first breaker Ctrl selects the operation mode of the two insulated sensor interfaces, the second one selects the minimum permissible intensity value, from 0% to 10%, and the third one selects the number of progressive turning off levels.

FIG. 12 shows a typical turning off curve wherein the transitions between intensity levels show a 5%/250 ms slope.

The progressive turning off time will always be the same: 1 hour, independently of the number of intermediate levels selected.

### Soft Transitions

Transitions between different luminous intensity levels are soft for a better visual comfort according to FIG. 13. The emergency ballast is designed comprising four versions:
a) self-ranging ballast with 60 watts luminaire and multivoltage ballast;
b) self-ranging dimmable and multivoltage ballast with 60 watts luminaire, three-level progressive breaker with sensors;
c) emergency ballast and 90 minutes backup battery with 62 watts luminaire, multivoltage and recharging regulation system and;
d) dimmable emergency ballast and Ni, Cd backup battery with 62 watts luminaire.

The regulated electricity supply source in its four versions shows the following features:

Power in watts a) 62.7 b) 62.9 c) 64.8 d) 64.9
Supply voltage in Volts AC multivoltage 108-305 Vac input current;
Input current: Amp@ 277 Vac a) 0.226 b) 0.227 c) 0.234 d) 0.234.
Power Factor a) 98.2 at 272 Vac b) greater than 90% c) greater than 95% d) greater than 95%.
Current harmonic distortion (THD) a) 9.89 at 277 Vac b) under 20% c) under 15% d) under 15%.

### Materials:

Aluminum casting heat dissipating elements shell; and ABS illumination diffusion screen flame retardant automotive grade (5VA), high impact and UV protection protecting screen made of high impact and flame retardant polycarbonate (5VA).

Although preferred embodiments have been described and depicted in detail herein, it will be apparent to one of ordinary skill in the art that various modifications, additions, substitutions and the like can be made without departing from the spirit of the invention and that these are therefore considered to be within the scope of the invention as defined in the following claims and drawings.

1. A high intensity dimmable LEDs luminaire with emergency ballast for car parks or covered areas, of industrial or commercial type, for self-ranging fixed or dimmable use, comprising:
a) a square, rectangular or other shaped semi-concave rigid shell plastic structure for self-supporting the luminaire components;
b) electrical elements based on an AC current source, emergency ballast, and emergency batteries;
c) heat dissipating elements wherein the shell presents centrally along its length an inverted “U” shaped passage with internal reinforcements, while at its side ends, a fin type semi-concave structure is formed on each side, in which a plurality of enhanced bases are formed to support, each one, an integrated module for a substrate that is secured through the lower part to a plurality of LEDs pair card, while on the opposite side there is a series of heat dissipating cells;
d) a series of electrical elements being accommodated in the inner part of the inverted “U” passage comprising an electricity supply source that is a ballast with fixed or dimmable output, a set of emergency batteries, and an emergency ballast having an electricity source with a voltage control regulator; an electrical harness for normal or emergency interconnections, electricity supply and control elements;
e) a “U” shaped passage cover; and
f) a terminal screen as a luminaire complement tightly closing the shell through a mechanical seal.

2. The high intensity dimmable LEDs luminaire with emergency ballast for car parks or covered areas according to claim 1, wherein the mechanical seal is selected from a thermal tape with adhesive on both sides or a silicon thermal paste.

3. The high intensity dimmable LEDs luminaire with emergency ballast for car parks or covered areas according to claim 1, wherein the emergency ballast is an electricity Supply source having a voltage control regulator, comprising four design versions:
a) self-ranging fixed ballast with 60 watts luminaire and multivoltage ballast;
b) self-ranging fixed or dimmable multivoltage ballast with 60 watts luminaire, three-level progressive breaker with sensors;
c) emergency ballast and 90 minutes backup battery with 62 watts multivoltage luminaire, and recharging regulation system and;
d) dimmable emergency ballast and Ni, Cd backup battery with 62 watts luminaire.

4. The high intensity dimmable LEDs luminaire with emergency ballast for car parks or covered areas according to claim 3, wherein the electricity supply source regulator in its four versions comprises the following features: i) power in watts; ii) supply voltage, volts AC multivoltage; iii) input current: Amp@ 277 Vac; iv) power factor; and v) current harmonic distortion (THD).

5. The high intensity dimmable LEDs luminaire with emergency ballast for car parks or covered areas according to claim 1, further comprising two turning on and off movement sensors for intensity control for dimming operation of the luminaire.

6. The high intensity dimmable LEDs luminaire with emergency ballast for car parks or covered areas according to claim 1, wherein the heat dissipating elements further comprises a plurality of metal pieces placed vertically on LEDs dome and are made of aluminum, zinc or mixtures thereof.

7. The high intensity dimmable LEDs luminaire with emergency ballast for car parks or covered areas according to claim 1, further comprising heat dissipating elements which are adhered and secured onto a plurality of PCB or MCPCB cards through thermal tapes.

8. The high intensity dimmable LEDs luminaire with emergency ballast for car parks or covered areas according to claim 1, further comprising the following elements in the upper part of the shell: a) working test button breaker for the emergency system connected to the general electricity b) supply lines, c) securing fixtures for placement; and
c) compression glands.

9. The high intensity dimmable LEDs luminaire with emergency ballast for car parks or covered areas according to claim 1, wherein the screen is made of high impact and flame retardant polycarbonate.

10. The high intensity dimmable LEDs luminaire with emergency ballast for car parks or covered areas according to claim 1, wherein the luminaire provides a homogeneous diffusion of illumination according to delimited area of observation such that the relation between the maximum/minimum illumination ^{s} 1 or about 1.

11. The high intensity dimmable LEDs luminaire with emergency ballast for car parks or covered areas according to claim 1, wherein the luminaire further comprises a transition between light intensity level at a constant slope of 5%/250 ms.

12. The high intensity dimmable LEDs luminaire with emergency ballast for car parks or covered areas according to claim 5, wherein the turning on or of the luminaire is with a fixed or dimmable output while the supply voltage is self-regulated.

13. The high intensity dimmable LEDs luminaire with emergency ballast for car parks or covered areas according to claim 5, wherein the luminaire would turn itself on at 100% upon activation of any of the control input with movement sensors or in combination with a control board having a movement sensor with progressive turning off operation.

14. The high intensity dimmable LEDs luminaire with emergency ballast for car parks or covered areas according to claim 5, wherein the luminaire turns itself off automatically and progressively upon deactivation of both input Sens1 and Sens2.

15. The high intensity dimmable LEDs luminaire with emergency ballast for car parks or covered areas according to claim 5, wherein the luminaire further comprises a first breaker ctrl for selecting the operation mode of the two insulated sensor interfaces; a second breaker for selecting the minimum permissible intensity value from 0% to 10%; and a third breaker for selecting the number of progressive turning off levels.

16. The high intensity dimmable LEDs luminaire with emergency ballast for car parks or covered areas according to claim 4, wherein the power is selected from 62.7, 62.9, 64.8 or 64.9 watts.

17. The high intensity dimmable LEDs luminaire with emergency ballast for car parks or covered areas according to claim 4, wherein the supply voltage is 108-305 vac input current.

18. The high intensity dimmable LEDs luminaire with emergency ballast for car parks or covered areas according to claim 4, wherein the input current is selected from a)0.226; b) 0.227; c)0.234; or d)0.234 amperes.

19. The high intensity dimmable LEDs luminaire with emergency ballast for car parks or covered areas according to claim 4, wherein the power factor is selected from a) 98.2 at 272 vac; b) greater than 90%; c) greater than 95%; or d) greater than 95%.

20. The high intensity dimmable LEDs luminaire with emergency ballast for car parks or covered areas according to claim 4, wherein the current harmonic distortion (THD) is selected from a) 9.89 at 277 Vac; b) under 20%; c) under 15%; or d) under 15%.
